(19) United States
(12) Patent Application Publication
(10) Pub. No.: US 2023/0177378 A1
(43) Pub. Date: Jun. 8, 2023

(54) ORCHESTRATING FEDERATED LEARNING IN MULTI-INFRASTRUCTURES AND HYBRID INFRASTRUCTURES

(71) Applicant: International Business Machines Corporation, Armonk, NY (US)

(72) Inventors: HIFAZ HASSAN, Singapore (SG); Laura Wynter, Singapore (SG); CHAITANYA KUMAR, Singapore (SG); Ali Anwar, San Jose, CA (US)

(21) Appl. No.: 17/456,169

(22) Filed: Nov. 23, 2021

(51) Int. Cl. G06N 20/00

(52) U.S. Cl. CPC G06N 20/00

(57) ABSTRACT

A computer-implemented method and a computer system for orchestrating federated learning in multi-infrastructures and hybrid infrastructures. An infrastructure federated learning orchestrator deploys a container of an aggregator and containers of parties to respective infrastructures in an infrastructure cluster. The infrastructure federated learning orchestrator creates aggregator and party processes of federated learning across the respective infrastructures. The infrastructure federated learning orchestrator moves federated learning artifacts to the container of the aggregator and the containers of the parties. The infrastructure federated learning orchestrator executes federated learning training commands in the aggregator and party processes. The infrastructure federated learning orchestrator monitors failure events and performance metrics in the aggregator and party processes. The infrastructure federated learning orchestrator provides automated recovery of the aggregator and party processes, in response to detecting a functional failure or a performance issue.

### STATEMENT REGARDING PRIOR DISCLOSURES BY THE INVENTOR OR A JOINT INVENTOR

The following disclosure is submitted under 35 U.S.C. 102(b)(1)(A): DISCLOSURE: https://github.com/IBM/federated-learning-lib, Sep. 17, 2021

### BACKGROUND

The present invention relates generally to federated learning in multi-cloud infrastructures and hybrid cloud infrastructures, and more particularly to orchestrating federated learning in multi-cloud infrastructures and hybrid cloud infrastructures.

Federated learning is a distributed machine learning process, in which each participant node (or party) retains data locally and interacts with the other participants via a learning protocol. The main drivers behind federated learning are privacy and confidentiality concerns, regulatory compliance requirements, as well as the practicality of moving data to a central learning location. Deploying and monitoring federated machine learning jobs in production in multi-cloud infrastructures and hybrid cloud infrastructures is difficult, since parties’ (participants’) training runs may span across multiple cloud regions and need to be in sync with a centralized aggregator. As opposed to traditional machine learning, federated learning brings in new network related scenarios: (1) parties that sign up late and may want to join during the middle of a federated learning run and (2) byzantine behavior from parties during training. Given the distributed nature of federated learning training, recovering from individual node or party failures is tedious, as it may require manual troubleshooting and resolution.

### SUMMARY

In one aspect, a computer-implemented method for orchestrating federated learning in multi-infrastructures and hybrid infrastructures is provided. The method includes deploying, by an infrastructure federated learning orchestrator, a container of an aggregator and containers of parties to respective infrastructures in an infrastructure cluster. The method further includes creating, by the infrastructure federated learning orchestrator, aggregator and party processes of federated learning across the respective infrastructures. The method further includes moving, by the infrastructure federated learning orchestrator, federated learning artifacts to the container of the aggregator and the containers of the parties. The method further includes executing, by the infrastructure federated learning orchestrator, federated learning training commands in the aggregator and party processes. The method further includes monitoring, by the infrastructure federated learning orchestrator, failure events and performance metrics in the aggregator and party processes. The method further includes providing, by the infrastructure federated learning orchestrator, automated recovery of the aggregator and party processes, in response to detecting one of a functional failure and a performance issue.

In another aspect, a computer system for orchestrating federated learning in multi-infrastructures and hybrid infrastructures is provided. The computer system comprises one or more processors, one or more computer readable tangible storage devices, and program instructions stored on at least one of the one or more computer readable tangible storage devices for execution by at least one of the one or more processors. The program instructions are executable to: deploy, by an infrastructure federated learning orchestrator, a container of an aggregator and containers of parties to respective infrastructures in an infrastructure cluster; create, by the infrastructure federated learning orchestrator, aggregator and party processes of federated learning across the respective infrastructures; move, by the infrastructure federated learning orchestrator, federated learning artifacts to the container of the aggregator and the containers of the parties; execute, by the infrastructure federated learning orchestrator, federated learning training commands in the aggregator and party processes; monitor, by the infrastructure federated learning orchestrator, failure events and performance metrics in the aggregator and party processes; and provide, by the infrastructure federated learning orchestrator, automated recovery of the aggregator and party processes, in response to detecting one of a functional failure and a performance issue.

### BRIEF DESCRIPTION OF THE SEVERAL VIEWS OF THE DRAWINGS

FIG. 1 is a systematic diagram illustrating orchestrating federated learning in a multi-cloud and/or hybrid cloud cluster, in accordance with one embodiment of the present invention.

FIG. 2 is a flowchart showing operational steps of orchestrating federated learning in a multi-cloud and/or hybrid cloud cluster, in accordance with one embodiment of the present invention.

FIG. 3 is a flowchart showing operational steps of accepting or denying a party which signs up late for federated learning in a multi-cloud and/or hybrid cloud cluster, in accordance with one embodiment of the present invention.

FIG. 4 is a flowchart showing operational steps of monitoring and remediating a party functional failure in federated learning in a multi-cloud and/or hybrid cloud cluster, in accordance with one embodiment of the present invention.

FIG. 5 is a flowchart showing operational steps of monitoring and remediating a party performance related issue in federated learning in a multi-cloud and/or hybrid cloud cluster, in accordance with one embodiment of the present invention.

FIG. 6 is a flowchart showing operational steps of monitoring and remediating an aggregator functional failure in federated learning in a multi-cloud and/or hybrid cloud cluster, in accordance with one embodiment of the present invention.

FIG. 7 is a flowchart showing operational steps of monitoring and remediating an aggregator performance related issue in federated learning in a multi-cloud and/or hybrid cloud cluster, in accordance with one embodiment of the present invention.

FIG. 8 is a diagram illustrating components of a computing device or server, in accordance with one embodiment of the present invention.

FIG. 9 depicts a cloud computing environment, in accordance with one embodiment of the present invention.

FIG. 10 depicts abstraction model layers in a cloud computing environment, in accordance with one embodiment of the present invention.

### DETAILED DESCRIPTION

Embodiments of the present invention disclose an orchestrator framework to automate the launch of aggregator and party processes on different cloud cluster regions, to synchronize the training across the network, and monitor for failure events to recover from them. While achieving the above-mentioned goals, the orchestrator framework maintains the data privacy requirement of multi-cloud and/or hybrid cloud federated learning.

Embodiments of the present invention propose a multi-cloud and/or hybrid cloud federated learning orchestrator. The multi-cloud and/or hybrid cloud federated learning orchestrator permits automating the deployment and monitoring of aggregator and party processes using federated learning library docker images on a multi-cloud and/or hybrid cloud cluster or infrastructure cluster which is setup in different cloud regions. The different cloud regions may be hosted on same or different cloud providers. The multi-cloud and/or hybrid cloud federated learning orchestrator evaluates requests from late arriving parties and accepts or rejects the requests based on certain criteria. The multi-cloud and/or hybrid cloud federated learning orchestrator monitors failure events and performance metrics during federated learning training run, and further the multi-cloud and/or hybrid cloud federated learning orchestrator provides automated recovery of federated learning jobs. The multi-cloud and/or hybrid cloud federated learning orchestrator also provides mitigation against byzantine attacks by removing byzantine parties from federation learning. The multi-cloud and/or hybrid cloud federated learning orchestrator only have deployment access to the multi-cloud and/or hybrid cloud cluster or infrastructure, with no permission to persistent volume storage where training artifacts of the parties will be stored; therefore, the present invention ensures the data privacy guarantees of the federated learning in the multi-cloud and/or hybrid cloud cluster or infrastructure. The multi-cloud and/or hybrid cloud cluster or infrastructure cluster is facilitated by Kubernetes, OpenShift, or other eventual paradigms. Kubernetes is a container orchestration system for automating computer application deployment, scaling, and management. OpenShift is a Kubernetes container platform with full-stack automated operations to manage hybrid cloud, multi-cloud, and edge deployments.

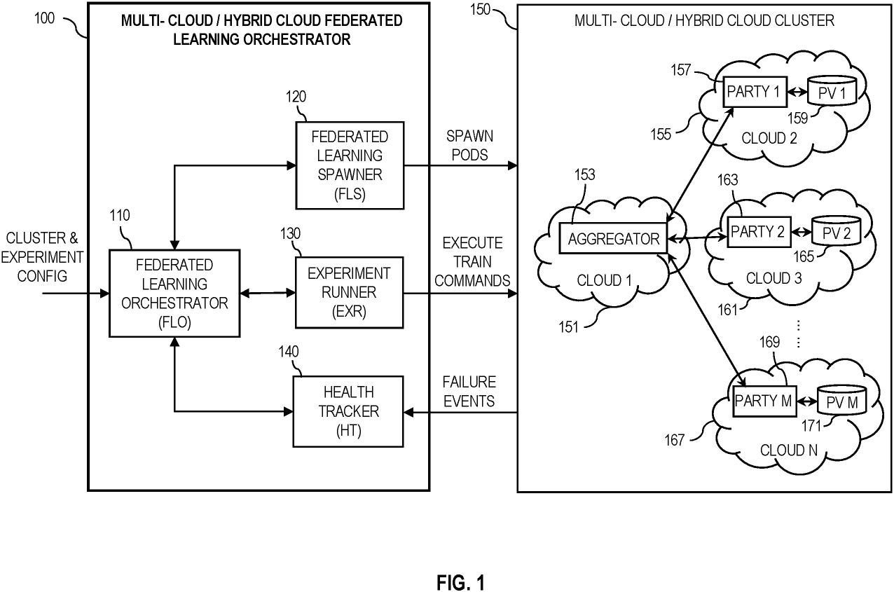

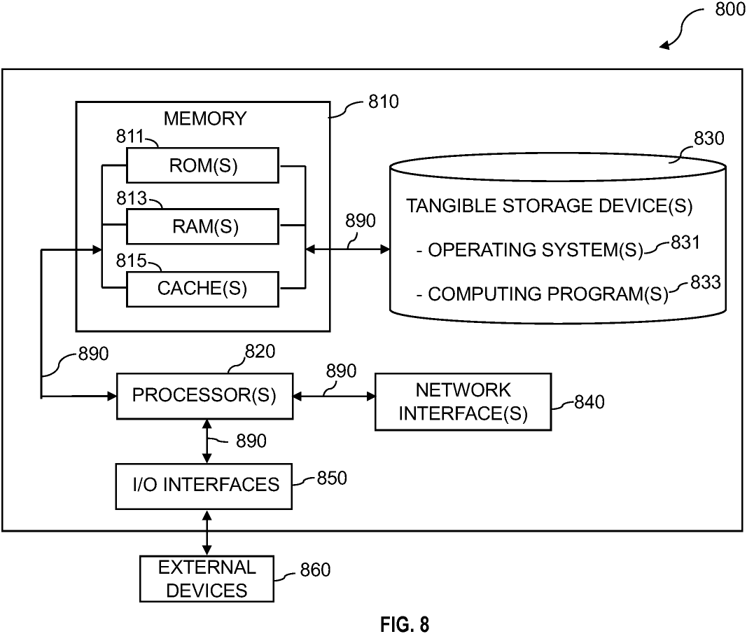

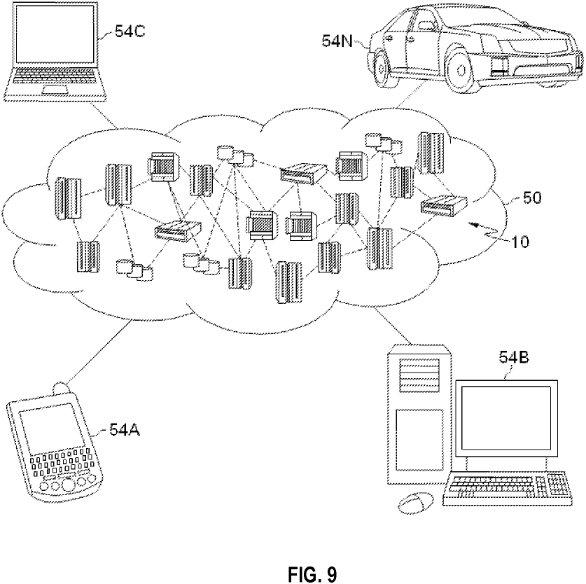

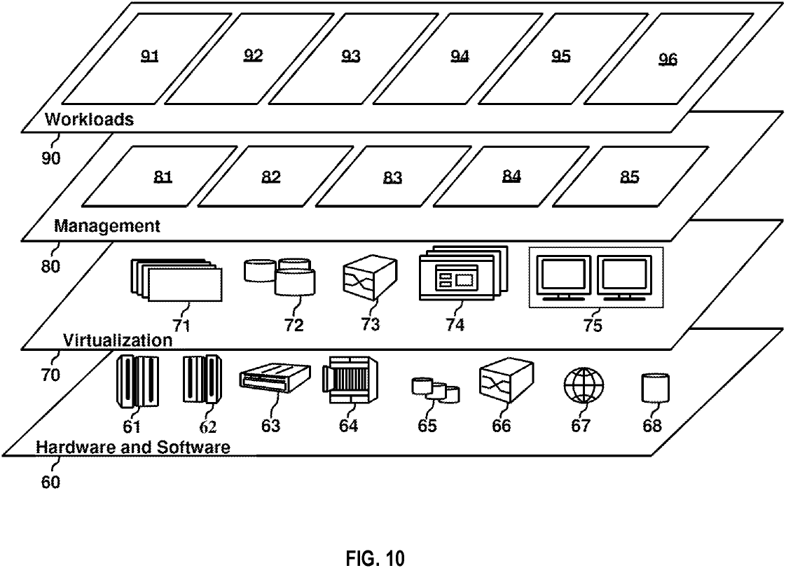

FIG. 1 is a systematic diagram illustrating multi-cloud and/or hybrid cloud federated learning orchestrator 100 for orchestrating federated learning in multi-cloud and/or hybrid cloud cluster 150, in accordance with one embodiment of the present invention. Multi-cloud and/or hybrid cloud federated learning orchestrator 100 is implemented on one or more computing devices or servers. A computing device or server is described in more detail in later paragraphs with reference to FIG. 8. Multi-cloud and/or hybrid cloud federated learning orchestrator 100 may be implemented in a cloud computing environment. The cloud computing environment, in which multi-cloud and/or hybrid cloud federated learning orchestrator 100 and multi-cloud and/or hybrid cloud cluster 150 are implemented, is described in more detail in later paragraphs with reference to FIG. 9 and FIG. 10.

As shown in FIG. 1, multi-cloud and/or hybrid cloud federated learning orchestrator 100 includes four components: federated learning orchestrator (FLO) 110, federated learning spawner (FLS) 120, experiment runner (EXR) 130, and health tracker (HT) 140. Multi-cloud and/or hybrid cloud cluster 150 include N cloud infrastructures: cloud 1 151, cloud 2 155, cloud 3 161, ... cloud N 167. Aggregator 153 is in cloud 1 150. Party 1 157 and its persistent volume storage PV 1 159 are in cloud 2 155. Party 2 163 and its persistent volume storage PV 2 165 are in cloud 3 161. Party M 169 and its persistent volume storage PV M 171 are in cloud N 167. Cloud 1 150, cloud 2 155, cloud 3 161, ... cloud N 167 may be located at different geographical regions.

On multi-cloud and/or hybrid cloud federated learning orchestrator 100, FLO 110 is an engine layer which exposes application programming interfaces (APIs) and handles requests to launch and manage federated learning jobs. FLO 110 receives cluster details and experiment setup details as inputs; for example, the cluster details include context names and namespaces, and experiment setup details include aggregator and party configurations. FLO 110 leverages three other components, FLS 120, EXR 130, and HT 140, to deploy and monitor jobs. The inter-component communication among FLS 120, EXR 130, and HT 140 inter-component communication happens through FLO 110. FLO 110 leverages a federated learning library (which runs as docker containers inside multi-cloud and/or hybrid cloud cluster 150) to create aggregator and party processes. FLO 110 supports running of multiple federated learning jobs in parallel and leverages auto-scaling capability of multi-cloud and/or hybrid cloud cluster 150 (for example a Kubernetes cluster) to scale in or scale out federated learning jobs.

Access of FLO 110 to multi-cloud and/or hybrid cloud cluster 150 is limited only for deployment resources, and FLO 110 has no permission to access Kubernetes secrets and persistent volume (PV) storage (PV 1 159, PV 2 165, ..., and PV M 171) where artefacts like training data, test data, and model checkpoints of parties (party 1 157, party 2 163, ..., and party M 169) are stored. Therefore, the data privacy requirement of federated learning is met.

FLO 110 may be deployed as an API service. FLO 110 may be packaged by using custom Kubernetes resources, installed by kubectl commands of Kubernetes, and deployed as an operator in toolkits such as Kubeflow. (Kubeflow is a free and open-source machine learning platform designed to enable using machine learning pipelines to orchestrate complicated workflows running on Kubernetes.)

On multi-cloud and/or hybrid cloud federated learning orchestrator 100, FLS 120 deploys containers of aggregator 153 and parties (party 1 157, party 2 163, ..., and party M 169) in multi-cloud and/or hybrid cloud cluster 150. In the embodiment where multi-cloud and/or hybrid cloud cluster 150 is facilitated by Kubernetes, FLS 120 deploys Pods of aggregator 153 and parties 1 157, party 2 163, ..., and party M 169). Pods are the smallest deployable units of computing that can be created and managed in Kubernetes, each is a group of one or more containers. FLS 120 sets up the network between aggregator and party processes. FLS 120 provides high level of authentication; FLS 120 uses cloud provider specific credentials in the Kube config file to authenticate and connect the aggregator and the parties to the Kubernetes cluster. FLS 120 spawns the Pod of the aggregator and copy the experiment aggregator config file to the Pod of the aggregator. FLS 120 deploys the aggregator as a websocket end point using the Kubernetes load balancer service. FLS 120 spawns Pods of respective parties across the Kubernetes cluster and copies the experiment party config files to respective party Pods. FLS 120 establishes websocket connections between the aggregator service and the party Pods to enable aggregator-party communication for federated learning. After the completion of the training jobs, FLS 120 terminates the aggregator Pod and party Pods to release central processing unit (CPU) and memory resources tied to the training jobs.

FLS 120 has no permission to access persistent volume (PV) storage or Kubernetes secrets. The Pods of respective parties spawned by FLS 120 have access to the training and test data stored in the PV storage in the form of cloud object storage. The connection details to the PV storage are specified in the data handler section of the party config files with credentials stored as Kubernetes secrets.

On multi-cloud and/or hybrid cloud federated learning orchestrator 100, EXR 130 executes federated learning training commands in aggregator and party processes across multi-cloud and/or hybrid cloud cluster 150. EXR 130 generates a unique experiment ID for a federated learning job and runs multiple trials for the experiment. EXR 130 coordinates execution of federated training commands for the experiment, including: start aggregator and party flask servers, register the parties to the aggregator, invoke local training of the registered parties through the aggregator, sync for the aggregator to send a global model to the parties, and save the global model of the aggregator and the local models of the parties in persistent volume storage. EXR 130 captures and saves experiment trace, including configuration settings and logs of the aggregator and the parties.

EXR 130 detects and removes byzantine parties from the federation learning. Aggregator 153 identifies byzantine parties which send malicious updates (weights or gradients) to aggregator 153. When a byzantine party is identified, aggregator 153 defines a byzantine attack event. EXR 130 listens for the byzantine attack event from aggregator 153. Once detecting the byzantine attack event, EXR 130 invokes FLS 120 to remove the byzantine party. FLS 120 removes containers (e.g., Pods in the Kubernetes cluster) of the byzantine parties from the federated learning.

On multi-cloud and/or hybrid cloud federated learning orchestrator 100, HT 140 hooks into aggregator and party processes to monitors failure events and performance metrics, and further HT 140 provides automated remediation of failures. HT 140 monitors party functional failures, party performance related issues, aggregator functional failures, and aggregator performance related issues.

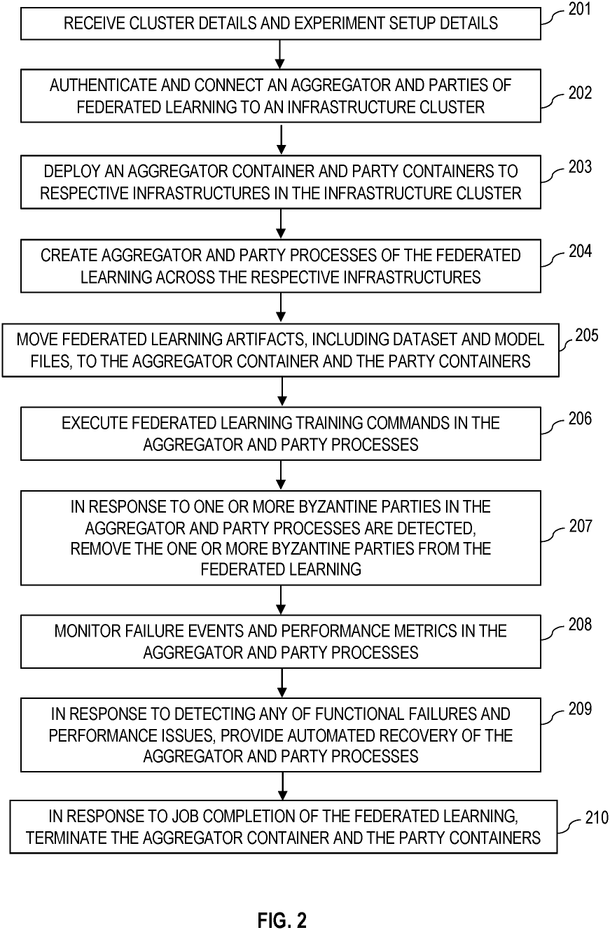

FIG. 2 is a flowchart showing operational steps of orchestrating federated learning in a multi-cloud and/or hybrid cloud cluster, in accordance with one embodiment of the present invention. The operational steps are implemented by a multi-cloud and/or hybrid cloud federated learning orchestrator (in the embodiment shown in FIG. 1, multi-cloud and/or hybrid cloud federated learning orchestrator 100). The multi-cloud and/or hybrid cloud federated learning orchestrator is hosted by one or more computing devices or servers (or by a computer system).

At step 201, the multi-cloud and/or hybrid cloud federated learning orchestrator receives cluster details and experiment setup details for the federated learning in the multi-cloud and/or hybrid cloud cluster. For example, the cluster details include context names and namespaces, and experiment setup details include aggregator and party configurations. In the embodiment shown in FIG. 1, federated learning orchestrator (FLO) 110 is a component implementing step 201.

At step 202, the multi-cloud and/or hybrid cloud federated learning orchestrator authenticates and connects an aggregator and parties of federated learning to an infrastructure cluster. In the embodiment shown in FIG. 1, federated learning spawner (FLS) 120 authenticates and connects the aggregator and the parties of federated learning to multi-cloud and/or hybrid cloud cluster 150.

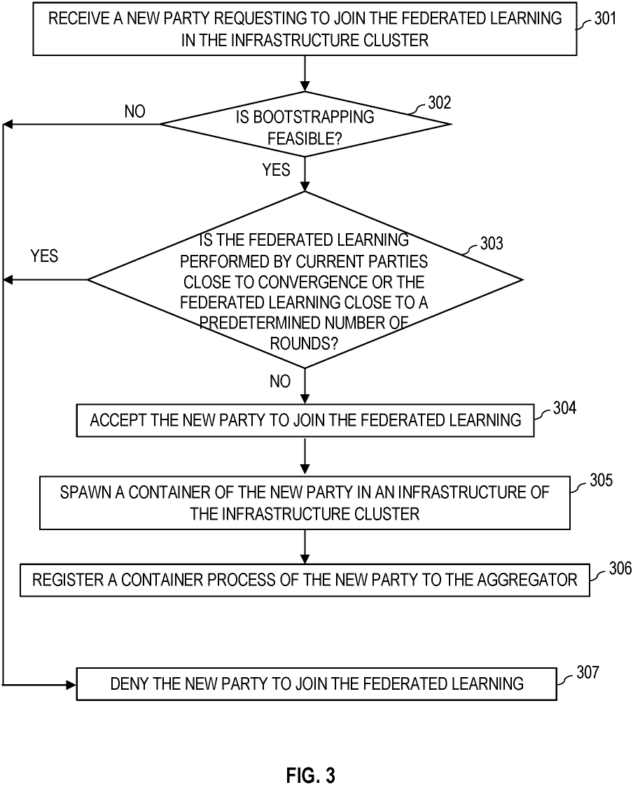

At step 203, the multi-cloud and/or hybrid cloud federated learning orchestrator deploys an aggregator container and party containers to respective infrastructures in the infrastructure cluster. In the embodiment where multi-cloud and/or hybrid cloud cluster 150 (shown in FIG. 1) is facilitated by Kubernetes, federated learning spawner (FLS) 120 deploys a Pod of aggregator 153 to cloud 1 151; federated learning spawner (FLS) 120 deploys a Pod of party 1 157, a Pod of party 2 163, ..., a Pod of party M 169 to cloud 2 155, cloud 3 161, ..., cloud N 167, respectively. The instantiation of a new party which signs up late will be described in detail in later paragraphs with reference to FIG. 3.

At step 204, the multi-cloud and/or hybrid cloud federated learning orchestrator creates aggregator and party processes of the federated learning across the respective infrastructures. In the embodiment shown in FIG. 1, to create aggregator and party processes, federated learning orchestrator (FLO) 110 leverages a federated learning library which runs as docker containers inside multi-cloud and/or hybrid cloud cluster 150. In the embodiment shown in FIG. 1, federated learning orchestrator (FLO) 110 sets up a network of the aggregator and party processes between aggregator 153 and the parties (party 1 157, party 2 163, ..., and party M 169).

At step 205, the multi-cloud and/or hybrid cloud federated learning orchestrator moves federated learning artifacts, including dataset and model files, to the aggregator container and the party containers. In the embodiment where multi-cloud and/or hybrid cloud cluster 150 (shown in FIG. 1) is facilitated by Kubernetes, federated learning spawner (FLS) 120 moves the federated learning artifacts to Pod of aggregator 153 and Pods of party 1 157, party 2 163, ..., and party M 169 which are in cloud 1 151, cloud 2 155, cloud 3 161, ..., cloud N 167, respectively.

At step 206, the multi-cloud and/or hybrid cloud federated learning orchestrator executes federated learning training commands in the aggregator and party processes. In the embodiment shown in FIG. 1, experiment runner (EXR) 130 executes federated learning training commands in the aggregator and party processes across cloud infrastructures in multi-cloud and/or hybrid cloud cluster 150, and experiment runner (EXR) 130 coordinates execution of federated training commands for experiment.

At step 207, the multi-cloud and/or hybrid cloud federated learning orchestrator, in response to one or more byzantine parties in the aggregator and party processes are detected, removes the one or more byzantine parties from the federated learning. In the embodiment shown in FIG. 1, aggregator 153 identifies the one or more byzantine parties sending malicious updates. Experiment runner (EXR) 130 listens for one or more byzantine attack events from aggregator 153. Once the one or more byzantine attack event are detected, experiment runner (EXR) 130 invokes federated learning spawner (FLS) 120 to remove the one or more byzantine parties. In the embodiment where multi-cloud and/or hybrid cloud cluster 150 (shown in FIG. 1) is facilitated by Kubernetes, federated learning spawner (FLS) 120 removes Pods of the one or more byzantine parties from one or more infrastructures in multi-cloud and/or hybrid cloud cluster 150.

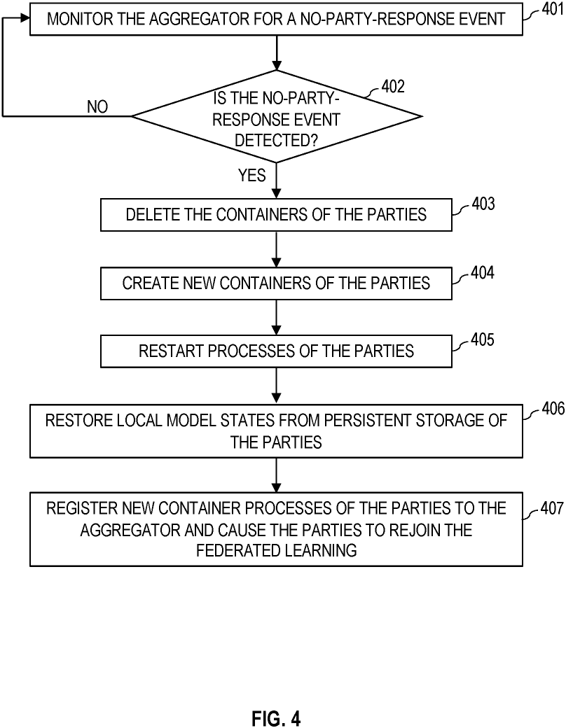

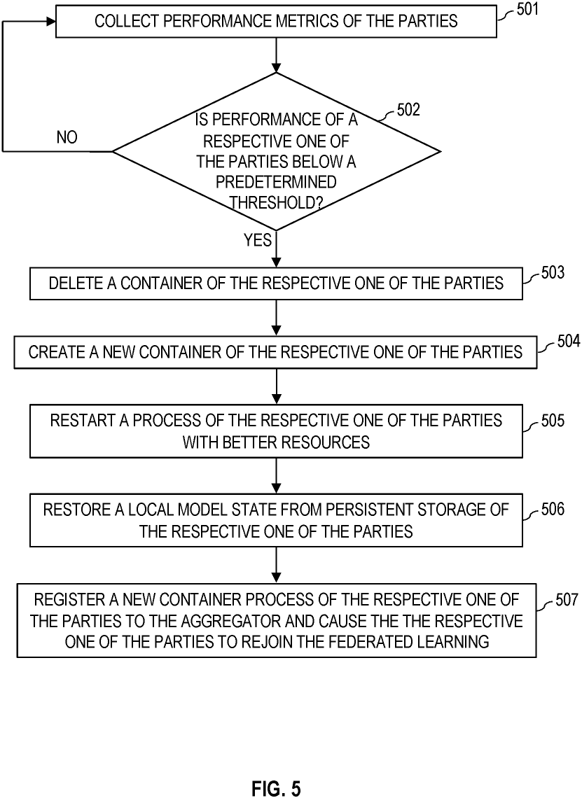

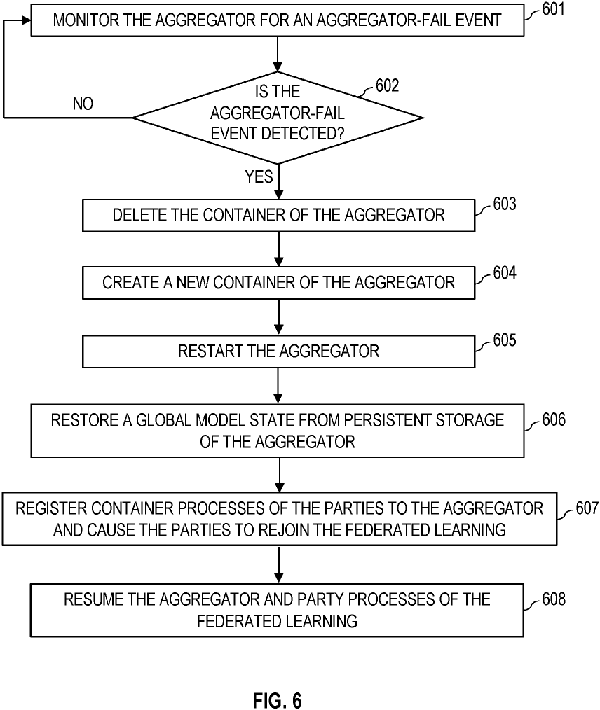

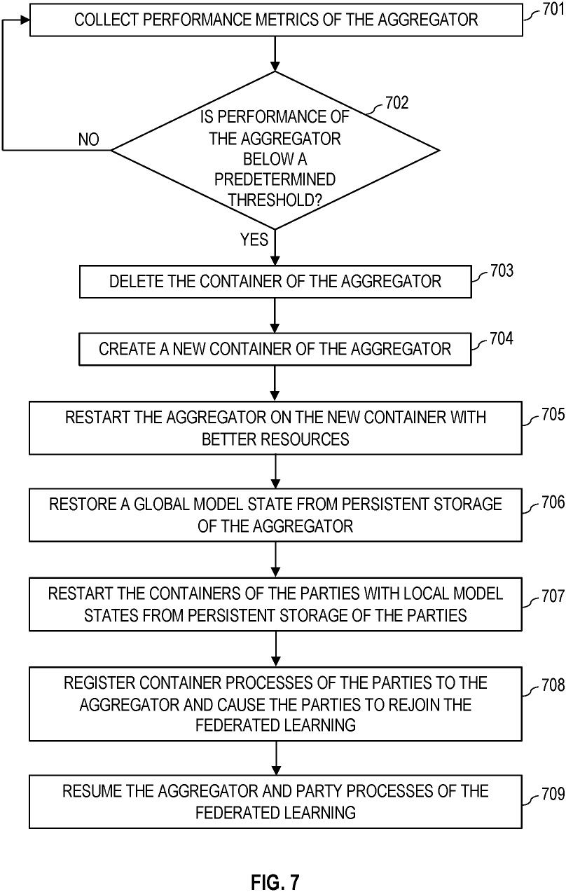

At step 208, the multi-cloud and/or hybrid cloud federated learning orchestrator monitors failure events and performance metrics in the aggregator and party processes. In response to detecting a functional failure or a performance issue, at step 209, the multi-cloud and/or hybrid cloud federated learning orchestrator provides automated recovery of the aggregator and party processes. In the embodiment shown in FIG. 1, health tracker (HT) 140 monitors the functional failures and the performance issues; once a functional failure or a performance issue is detected, health tracker (HT) 140 invokes experiment runner (EXR) 130 to remediate the functional failure or the performance issue. In later paragraph with reference to FIG. 4, monitoring and remediating a party functional failure will be discussed in detail. In later paragraph with reference to FIG. 5, monitoring and remediating a party performance related issue will be discussed in detail. In later paragraph with reference to FIG. 6, monitoring and remediating an aggregator functional failure will be discussed in detail. In later paragraph with reference to FIG. 7, monitoring and remediating an aggregator performance related issue will be discussed in detail.

In response to job completion of the federated learning, at step 210, the multi-cloud and/or hybrid cloud federated learning orchestrator terminates the aggregator container and the party containers. In the embodiment where multi-cloud and/or hybrid cloud cluster 150 (shown in FIG. 1) is facilitated by Kubernetes, federated learning spawner (FLS) 120 terminates the Pod of aggregator 153 and the Pods of party 1 157, party 2 163, ..., and party M 169, to release CPU and memory resources in cloud 1 151, cloud 2 155, cloud 3 161, ... cloud N 167.

FIG. 3 is a flowchart showing operational steps of accepting or denying a party which signs up late for federated learning in a multi-cloud and/or hybrid cloud cluster, in accordance with one embodiment of the present invention. The operational steps are implemented by a multi-cloud and/or hybrid cloud federated learning orchestrator (in the embodiment shown in FIG. 1, multi-cloud and/or hybrid cloud federated learning orchestrator 100). The multi-cloud and/or hybrid cloud federated learning orchestrator is hosted by one or more computing devices or servers (or by a computer system).

At step 301, the multi-cloud and/or hybrid cloud federated learning orchestrator receives a new party requesting to join the federated learning in the infrastructure cluster. In the example shown in FIG. 1, federated learning orchestrator (FLO) 110 receives the request of the new party to join federated learning in multi-cloud and/or hybrid cloud cluster 150.

At step 302, the multi-cloud and/or hybrid cloud federated learning orchestrator determines whether bootstrapping is feasible. In response to determining that the bootstrapping is not feasible (NO branch of decision step 302), the multi-cloud and/or hybrid cloud federated learning orchestrator at step 307 denies the new party to join the federated learning. In the example shown in FIG. 1, federated learning spawner (FLS) 120 executes steps 302 and 307.

In response to determining that the bootstrapping is feasible (YES branch of decision step 302), at step 303, the multi-cloud and/or hybrid cloud federated learning orchestrator further determines whether the federated learning performed by current parties is close to convergence or the federated learning is close to a predetermined number of rounds. When the federated learning performed by current parties is close to convergence, the federated learning is close to completion; when the federated learning is close to a predetermined number of rounds, the federated learning is also close to completion; therefore, under either of the cases, there is no need to accept the new party. In response to determining that the federated learning performed by the current parties is close to convergence or the federated learning is close to the predetermined number of rounds (YES branch of decision step 303), the multi-cloud and/or hybrid cloud federated learning orchestrator at step 307 denies the new party to join the federated learning. In the example shown in FIG. 1, federated learning spawner (FLS) 120 executes steps 303 and 307.

In response to determining that the federated learning performed by current parties is not close to convergence and the federated learning is not close to the predetermined number of rounds (NO branch of decision step 303), the multi-cloud and/or hybrid cloud federated learning orchestrator at step 304 accepts the new party to join the federated learning. The multi-cloud and/or hybrid cloud federated learning orchestrator sets current weights of the federated learning as the weights of the new party. At step 305, the multi-cloud and/or hybrid cloud federated learning orchestrator spawns a container of the new party in an infrastructure of the infrastructure cluster. At step 306, the multi-cloud and/or hybrid cloud federated learning orchestrator registers a container process of the new party to the aggregator. In the example shown in FIG. 1, federated learning spawner (FLS) 120 executes steps 304, 305, and 306. In the embodiment of a Kubernetes cluster, federated learning spawner (FLS) 120 spawns a Pod of the new party and registers the Pod to aggregator 153 in multi-cloud and/or hybrid cloud cluster 150.

FIG. 4 is a flowchart showing operational steps of monitoring and remediating a party functional failure in federated learning in a multi-cloud and/or hybrid cloud cluster, in accordance with one embodiment of the present invention. The operational steps are implemented by a multi-cloud and/or hybrid cloud federated learning orchestrator (in the embodiment shown in FIG. 1, multi-cloud and/or hybrid cloud federated learning orchestrator 100). The multi-cloud and/or hybrid cloud federated learning orchestrator is hosted by one or more computing devices or servers (or by a computer system).

At step 401, the multi-cloud and/or hybrid cloud federated learning orchestrator monitors the aggregator for a no-party-response event. For example, in FIG. 1, the no-party-response event is that none of party 1 157, party 2 163, ..., and party M 169 responds aggregator 153. At step 402, the multi-cloud and/or hybrid cloud federated learning orchestrator determines whether the no-party-response event is detected. In the embodiment shown in FIG. 1, health tracker (HT) 140 implements step 401 and step 402. In response to determining that the no-party-response event is not detected (NO branch of decision step 402), the multi-cloud and/or hybrid cloud federated learning orchestrator reiterates step 401 to keep monitoring the aggregator for the no-party-response event.

In response to determining that the no-party-response event is detected (YES branch of decision step 402), at step 403, the multi-cloud and/or hybrid cloud federated learning orchestrator delete the containers of the parties. At step 404, the multi-cloud and/or hybrid cloud federated learning orchestrator creates new containers of the parties. In the embodiment shown in FIG. 1, health tracker (HT) 140 invokes federated learning spawner (FLS) 120 to delete and recreate the containers of party 1 157, party 2 163, ..., and party M 169. In the embodiment of a Kubernetes cluster, health tracker (HT) 140 invokes federated learning spawner (FLS) 120 to delete and recreate Pods of these parties.

At step 405, the multi-cloud and/or hybrid cloud federated learning orchestrator restarts processes of the parties. At step 406, the multi-cloud and/or hybrid cloud federated learning orchestrator restores local model states from persistent storage of the parties. In the embodiment shown in FIG. 1, health tracker (HT) 140 invokes experiment runner (EXR) 130 to restart the processes of party 1 157, party 2 163, ..., and party M 169 and to restores the local model states from persistent volume storage PV 1 159, persistent volume storage PV 2 165, and persistent volume storage PV M 171.

At step 407, the multi-cloud and/or hybrid cloud federated learning orchestrator registers new container processes of the parties to the aggregator and causes the parties to rejoin the federated learning. In the embodiment shown in FIG. 1, health tracker (HT) 140 invokes experiment runner (EXR) 130 to register the new container processes of party 1 157, party 2 163, ..., and party M 169 to aggregator 153; experiment runner (EXR) 130 causes party 1 157, party 2 163, ..., and party M 169 rejoin the federated learning in multi-cloud and/or hybrid cloud cluster 150. In the embodiment of a Kubernetes cluster, health tracker (HT) 140 invokes experiment runner (EXR) 130 to newly created Pods of these parties to aggregator 153.

FIG. 5 is a flowchart showing operational steps of monitoring and remediating a party performance related issue in federated learning in a multi-cloud and/or hybrid cloud cluster, in accordance with one embodiment of the present invention. The operational steps are implemented by a multi-cloud and/or hybrid cloud federated learning orchestrator (in the embodiment shown in FIG. 1, multi-cloud and/or hybrid cloud federated learning orchestrator 100). The multi-cloud and/or hybrid cloud federated learning orchestrator is hosted by one or more computing devices or servers (or by a computer system).

At step 501, the multi-cloud and/or hybrid cloud federated learning orchestrator collects performance metrics of the parties. At step 502, the multi-cloud and/or hybrid cloud federated learning orchestrator determines whether performance of a respective one of the parties is below a predetermined threshold (e.g., the respective one of the parties takes longer to train and lags). In the embodiment shown in FIG. 1, health tracker (HT) 140 on multi-cloud and/or hybrid cloud federated learning orchestrator 100 collects performance metrics of party 1 157, party 2 163, ..., and party M 169 in multi-cloud and/or hybrid cloud cluster 150, and health tracker (HT) 140 determines whether performance of any of party 1 157, party 2 163, ..., and party M 169 is below the predetermined threshold.

In response to determining that the performance of the respective one of the parties is not below the predetermined threshold (NO branch of decision step 502), the multi-cloud and/or hybrid cloud federated learning orchestrator reiterates step 501 to keep collecting the performance metrics of the parties. In the embodiment shown in FIG. 1, health tracker (HT) 140 keeps collecting the performance metrics of party 1 157, party 2 163, ..., and party M 169.

In response to determining that the performance of the respective one of the parties is below the predetermined threshold (YES branch of decision step 502), at step 503, the multi-cloud and/or hybrid cloud federated learning orchestrator deletes a container of the respective one of the parties. At step 504, the multi-cloud and/or hybrid cloud federated learning orchestrator creates a new container of the respective one of the parties. In the embodiment shown in FIG. 1, once health tracker (HT) 140 determines that the performance of one of party 1 157, party 2 163, ..., and party M 169 is below the predetermined threshold, health tracker (HT) 140 invokes federated learning spawner (FLS) 120 to delete and recreate the container of the party whose performance is below the predetermined threshold. In the embodiment of a Kubernetes cluster, health tracker (HT) 140 invokes federated learning spawner (FLS) 120 to delete and recreate a Pod of the party whose performance is below the predetermined threshold.

At step 505, the multi-cloud and/or hybrid cloud federated learning orchestrator restarts a process of the respective one of the parties with better resources (including better CPU, memory, and storage). The better resources will improve the performance of the respective one of the parties. At step 506, the multi-cloud and/or hybrid cloud federated learning orchestrator restores a local model state from persistent storage of the respective one of the parties. In the embodiment shown in FIG. 1, health tracker (HT) 140 invokes experiment runner (EXR) 130 to restart a process of the party whose performance has been below the predetermined threshold and to restores the local model state from persistent volume storage of the party whose performance has been below the predetermined threshold.

At step 507, the multi-cloud and/or hybrid cloud federated learning orchestrator registers a new container process of the respective one of the parties to the aggregator and causes the respective one of the parties to rejoin the federated learning. In the embodiment shown in FIG. 1, health tracker (HT) 140 invokes experiment runner (EXR) 130 to register the new container process of the party whose performance has been below the predetermined threshold; experiment runner (EXR) 130 brings the party back to the federated learning in multi-cloud and/or hybrid cloud cluster 150. In the embodiment of a Kubernetes cluster, health tracker (HT) 140 invokes experiment runner (EXR) 130 to register the newly created Pod.

FIG. 6 is a flowchart showing operational steps of monitoring and remediating an aggregator functional failure in federated learning in a multi-cloud and/or hybrid cloud cluster, in accordance with one embodiment of the present invention. The operational steps are implemented by a multi-cloud and/or hybrid cloud federated learning orchestrator (in the embodiment shown in FIG. 1, multi-cloud and/or hybrid cloud federated learning orchestrator 100). The multi-cloud and/or hybrid cloud federated learning orchestrator is hosted by one or more computing devices or servers (or by a computer system).

At step 601, the multi-cloud and/or hybrid cloud federated learning orchestrator monitors the aggregator for an aggregator-fail event. At step 602, the multi-cloud and/or hybrid cloud federated learning orchestrator determines whether the aggregator-fail event is detected. In the embodiment shown in FIG. 1, health tracker (HT) 140 monitors aggregator 153 in cloud 151 and determines whether the fail event of aggregator 153 is detected.

In response to determining that the aggregator-fail event is not detected (NO branch of decision step 602), the multi-cloud and/or hybrid cloud federated learning orchestrator reiterates step 601 to keep monitoring the aggregator for the aggregator-fail event. In the embodiment shown in FIG. 1, health tracker (HT) 140 keeps monitoring aggregator 153.

In response to determining that the aggregator-fail event is detected (YES branch of decision step 602), at step 603, the multi-cloud and/or hybrid cloud federated learning orchestrator deletes the container of the aggregator. At step 604, the multi-cloud and/or hybrid cloud federated learning orchestrator creates a new container of the aggregator. In the embodiment shown in FIG. 1, health tracker (HT) 140 invokes federated learning spawner (FLS) 120 to delete the container of aggregator 153 and create the new container of aggregator 153. In the embodiment of a Kubernetes cluster, health tracker (HT) 140 invokes federated learning spawner (FLS) 120 to delete and recreate a Pod of aggregator 153.

At step 605, the multi-cloud and/or hybrid cloud federated learning orchestrator restarts the aggregator. At step 606, the multi-cloud and/or hybrid cloud federated learning orchestrator restores a global model state from persistent storage of the aggregator. In the embodiment shown in FIG. 1, health tracker (HT) 140 invokes experiment runner (EXR) 130 to restart aggregator 153 and restore the global model state from persistent storage of aggregator 153.

At step 607, the multi-cloud and/or hybrid cloud federated learning orchestrator registers container processes of the parties to the aggregator and cause the parties to rejoin the federated learning. In the embodiment shown in FIG. 1, health tracker (HT) 140 invokes experiment runner (EXR) 130 to register a container process of party 1 157 in cloud 2 155, a container process of party 2 163 in cloud 3 161, ..., a container process of party M 169 in cloud N 167, and experiment runner (EXR) 130 causes these parties to rejoin the federated learning in multi-cloud and/or hybrid cloud cluster 150. In the embodiment of a Kubernetes cluster, health tracker (HT) 140 invokes experiment runner (EXR) 130 to register Pods of these parties to aggregator 153.

At step 608, the multi-cloud and/or hybrid cloud federated learning orchestrator resumes the aggregator and party processes of the federated learning. In the embodiment shown in FIG. 1, health tracker (HT) 140 invokes experiment runner (EXR) 130 to resume the aggregator and party processes of the federated learning in multi-cloud and/or hybrid cloud cluster 150.

FIG. 7 is a flowchart showing operational steps of monitoring and remediating an aggregator performance related issue in federated learning in a multi-cloud and/or hybrid cloud cluster, in accordance with one embodiment of the present invention. The operational steps are implemented by a multi-cloud and/or hybrid cloud federated learning orchestrator (in the embodiment shown in FIG. 1, multi-cloud and/or hybrid cloud federated learning orchestrator 100). The multi-cloud and/or hybrid cloud federated learning orchestrator is hosted by one or more computing devices or servers (or by a computer system).

At step 701, the multi-cloud and/or hybrid cloud federated learning orchestrator collects performance metrics of the aggregator. At step 702, the multi-cloud and/or hybrid cloud federated learning orchestrator determines whether performance of the aggregator is below a predetermined threshold (e.g., the aggregator takes longer to train and lags). In the embodiment shown in FIG. 1, health tracker (HT) 140 on multi-cloud and/or hybrid cloud federated learning orchestrator 100 collects performance metrics of aggregator 153 in multi-cloud and/or hybrid cloud cluster 150, and health tracker (HT) 140 determines whether performance of aggregator 153 is below the predetermined threshold.

In response to determining that the performance of the aggregator is not below the predetermined threshold (NO branch of decision step 702), the multi-cloud and/or hybrid cloud federated learning orchestrator reiterates step 701 to keep collecting the performance metrics of the aggregator. In the embodiment shown in FIG. 1, health tracker (HT) 140 keeps collecting the performance metrics of aggregator 153.

In response to determining that the performance of the aggregator is below the predetermined threshold (YES branch of decision step 702), at step 703, the multi-cloud and/or hybrid cloud federated learning orchestrator deletes the container of the aggregator. At step 704, the multi-cloud and/or hybrid cloud federated learning orchestrator creates a new container of the aggregator. In the embodiment shown in FIG. 1, once health tracker (HT) 140 determines that the performance of aggregator 153 is below the predetermined threshold, health tracker (HT) 140 invokes federated learning spawner (FLS) 120 to delete the old container of aggregator 153 and to create the new container of aggregator 153. In the embodiment of a Kubernetes cluster, health tracker (HT) 140 invokes federated learning spawner (FLS) 120 to delete an old Pod of aggregator 153 and to create a new Pod of aggregator 153.

At step 705, the multi-cloud and/or hybrid cloud federated learning orchestrator restarts the aggregator on the new container with better resources. The better resources will improve the performance of the aggregator. At step 706, the multi-cloud and/or hybrid cloud federated learning orchestrator restores a global model state from persistent storage of the aggregator. In the embodiment shown in FIG. 1, health tracker (HT) 140 invokes experiment runner (EXR) 130 to restart aggregator 153 and restore the global model state from persistent storage of aggregator 153.

At step 707, the multi-cloud and/or hybrid cloud federated learning orchestrator restarts the containers of the parties with local model states from persistent storage of the parties. In the embodiment shown in FIG. 1, health tracker (HT) 140 invokes experiment runner (EXR) 130 to restart the containers of party 1 157, party 2 163, ..., and party M 169 with the local model states; health tracker (HT) 140 invokes experiment runner (EXR) 130 to restore the local model states, from persistent volume storage PV 1 159 for party 1 157, persistent volume storage PV 2 165 for party 2 163, and persistent volume storage PV M 171 for party M 169. In the embodiment of a Kubernetes cluster, health tracker (HT) 140 invokes experiment runner (EXR) 130 to restart Pods of these parties.

At step 708, the multi-cloud and/or hybrid cloud federated learning orchestrator registers container processes of the parties to the aggregator and cause the parties to rejoin the federated learning. In the embodiment shown in FIG. 1, health tracker (HT) 140 invokes experiment runner (EXR) 130 to register the container processes of party 1 157, party 2 163, ..., and party M 169 to aggregator 153 and to cause these parties to rejoin the federated learning in multi-cloud and/or hybrid cloud cluster 150. In the embodiment of a Kubernetes cluster, health tracker (HT) 140 invokes experiment runner (EXR) 130 to register Pods of party 1 157, party 2 163, ..., and party M 169 to aggregator 153.

At step 709, the multi-cloud and/or hybrid cloud federated learning orchestrator resumes the aggregator and party processes of the federated learning. In the embodiment shown in FIG. 1, health tracker (HT) 140 invokes experiment runner (EXR) 130 to resume the aggregator and party processes of the federated learning in multi-cloud and/or hybrid cloud cluster 150.

FIG. 8 is a diagram illustrating components of computing device or server 800, in accordance with one embodiment of the present invention. It should be appreciated that FIG. 8 provides only an illustration of one implementation and does not imply any limitations; different embodiments may be implemented.

Referring to FIG. 8, computing device or server 800 includes processor(s) 820, memory 810, and tangible storage device(s) 330. In FIG. 8, communications among the above-mentioned components of computing device or server 800 are denoted by numeral 890. Memory 810 includes ROM(s) (Read Only Memory) 811, RAM(s) (Random Access Memory) 813, and cache(s) 815. One or more operating systems 831 and one or more computer programs 833 reside on one or more computer readable tangible storage device(s) 830.

Computing device or server 800 further includes I/O interface(s) 850. I/O interface(s) 850 allows for input and output of data with external device(s) 860 that may be connected to computing device or server 800. Computing device or server 800 further includes network interface(s) 840 for communications between computing device or server 800 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A nonexhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics Are as Follows

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models Are as Follows

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models Are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide prearrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of orchestrating federated learning in multi-cloud infrastructures and hybrid cloud infrastructures.

What is claimed is:

1. A computer-implemented method for orchestrating federated learning in multi-infrastructures and hybrid infrastructures, the method comprising:
deploying, by an infrastructure federated learning orchestrator, a container of an aggregator and containers of parties to respective infrastructures in an infrastructure cluster;
creating, by the infrastructure federated learning orchestrator, aggregator and party processes of federated learning across the respective infrastructures;
moving, by the infrastructure federated learning orchestrator, federated learning artifacts to the container of the aggregator and the containers of the parties;
executing, by the infrastructure federated learning orchestrator, federated learning training commands in the aggregator and party processes;
monitoring, by the infrastructure federated learning orchestrator, failure events and performance metrics in the aggregator and party processes; and
providing, by the infrastructure federated learning orchestrator, automated recovery of the aggregator and party processes, in response to detecting one of a functional failure and a performance issue.

2. The computer-implemented method of claim 1, further comprising:
receiving, by the infrastructure federated learning orchestrator, cluster details and experiment setup details for the federated learning; and
authenticating and connecting, by the infrastructure federated learning orchestrator, the aggregator and the parties to respective infrastructures.

3. The computer-implemented method of claim 1, further comprising:
monitoring, by the infrastructure federated learning orchestrator, one or more byzantine parties in the aggregator and party processes; and
in response to determining the one or more byzantine parties are detected, removing, by the infrastructure federated learning orchestrator, the one or more byzantine parties from the federated learning.

4. The computer-implemented method of claim 1, further comprising:
in response to job completion of the federated learning, terminating, by the infrastructure federated learning orchestrator, the container of the aggregator and the containers of the parties in the respective infrastructures.

5. The computer-implemented method of claim 1, further comprising:
receiving, by the infrastructure federated learning orchestrator, a new party requesting to join the federated learning in the infrastructure cluster;
determining, by the infrastructure federated learning orchestrator, whether bootstrapping is feasible;
in response to determining that the bootstrapping is feasible, determining, by the infrastructure federated learning orchestrator, whether the federated learning performed by current parties is close to completion;
in response to determining that the federated learning performed by the current parties is not close to completion, accepting, by the infrastructure federated learning orchestrator, the new party to join the federated learning;
spawning, by the infrastructure federated learning orchestrator, a container of the new party in an infrastructure of the infrastructure cluster; and
registering, by the infrastructure federated learning orchestrator, a container process of the new party to the aggregator.

6. The computer-implemented method of claim 5, further comprising:
in response to determining one of: the bootstrapping is not feasible and the federated learning performed by the current parties is close to completion, denying, by the infrastructure federated learning orchestrator, the new party to join the federated learning.

7. The computer-implemented method of claim 1, further comprising:
monitoring, by the infrastructure federated learning orchestrator, the aggregator for a no-party-response event;
in response to determining that the no-party-response event is detected, deleting, by the infrastructure federated learning orchestrator, the containers of the parties;
creating, by the infrastructure federated learning orchestrator, new containers of the parties;
restarting, by the infrastructure federated learning orchestrator, processes of the parties;
restoring, by the infrastructure federated learning orchestrator, local model states from persistent storage of the parties;
registering, by the infrastructure federated learning orchestrator, new container processes of the parties to the aggregator; and
causing, by the infrastructure federated learning orchestrator, the parties to rejoin the federated learning.

8. The computer-implemented method of claim 1, further comprising:
collecting, by the infrastructure federated learning orchestrator, performance metrics of the parties;
in response to determining that performance of a respective one of the parties is below a predetermined threshold, deleting, by the infrastructure federated learning orchestrator, a container of the respective one of the parties;
creating, by the infrastructure federated learning orchestrator, a new container of the respective one of the parties;
restarting, by the infrastructure federated learning orchestrator, a process of the respective one of the parties, with better resources of the respective one of the parties;
restoring, by the infrastructure federated learning orchestrator, a local model state from persistent storage of the respective one of the parties;
registering, by the infrastructure federated learning orchestrator, a new container process to the aggregator; and
causing, by the infrastructure federated learning orchestrator, the respective one of the parties to rejoin the federated learning.

9. The computer-implemented method of claim 1, further comprising:
monitoring, by the infrastructure federated learning orchestrator, the aggregator for an aggregator-fail event;
in response to determining that the aggregator-fail event is detected, deleting, by the infrastructure federated learning orchestrator, the container of the aggregator;
creating, by the infrastructure federated learning orchestrator, a new container of the aggregator;
restarting, by the infrastructure federated learning orchestrator, the aggregator;
restoring, by the infrastructure federated learning orchestrator, a global model state from persistent storage of the aggregator;
registering, by the infrastructure federated learning orchestrator, container processes of the parties to the aggregator;
causing, by the infrastructure federated learning orchestrator, the parties to rejoin the federated learning; and
resuming, by the infrastructure federated learning orchestrator, the aggregator and party processes of the federated learning.

10. The computer-implemented method of claim 1, further comprising:
collecting, by the infrastructure federated learning orchestrator, performance metrics of the aggregator;
in response to determining that performance of the aggregator is below a predetermined threshold, deleting, by the infrastructure federated learning orchestrator, the container of the aggregator;
creating, by the infrastructure federated learning orchestrator, a new container of the aggregator;
restarting, by the infrastructure federated learning orchestrator, the aggregator on the new container with better resources;
restoring, by the infrastructure federated learning orchestrator, a global model state from persistent storage of the aggregator;
restarting, by the infrastructure federated learning orchestrator, the containers of the parties with local model states from persistent storage of the parties;
registering, by the infrastructure federated learning orchestrator, container processes of the parties to the aggregator;
causing, by the infrastructure federated learning orchestrator, the parties to rejoin the federated learning; and
resuming, by the infrastructure federated learning orchestrator, the aggregator and party processes of the federated learning.

11. A computer system for orchestrating federated learning in multi-infrastructures and hybrid infrastructures, the computer system comprising one or more processors, one or more computer readable tangible storage devices, and program instructions stored on at least one of the one or more computer readable tangible storage devices for execution by at least one of the one or more processors, the program instructions executable to:
deploy, by an infrastructure federated learning orchestrator, a container of an aggregator and containers of parties to respective infrastructures in an infrastructure cluster;
create, by the infrastructure federated learning orchestrator, aggregator and party processes of federated learning across the respective infrastructures;
move, by the infrastructure federated learning orchestrator, federated learning artifacts to the container of the aggregator and the containers of the parties;
execute, by the infrastructure federated learning orchestrator, federated learning training commands in the aggregator and party processes;
monitor, by the infrastructure federated learning orchestrator, failure events and performance metrics in the aggregator and party processes; and
provide, by the infrastructure federated learning orchestrator, automated recovery of the aggregator and party processes, in response to detecting one of a functional failure and a performance issue.

12. The computer system of claim 11, further comprising the program instructions executable to:
receive, by the infrastructure federated learning orchestrator, cluster details and experiment setup details for the federated learning; and
authenticate and connect, by the infrastructure federated learning orchestrator, the aggregator and the parties to respective infrastructures.

13. The computer system of claim 11, further comprising the program instructions executable to:
monitor, by the infrastructure federated learning orchestrator, one or more byzantine parties in the aggregator and party processes; and
in response to determining the one or more byzantine parties are detected, remove, by the infrastructure federated learning orchestrator, the one or more byzantine parties from the federated learning.

14. The computer system of claim 11, further comprising the program instructions executable to:
in response to job completion of the federated learning, terminate, by the infrastructure federated learning orchestrator, the container of the aggregator and the containers of the parties in the respective infrastructures.

15. The computer system of claim 11, further comprising the program instructions executable to:
receive, by the infrastructure federated learning orchestrator, a new party requesting to join the federated learning in the infrastructure cluster;
determine, by the infrastructure federated learning orchestrator, whether bootstrapping is feasible;
in response to determining that the bootstrapping is feasible, determine, by the infrastructure federated learning orchestrator, whether the federated learning performed by current parties is close to completion;
in response to determining that the federated learning performed by the current parties is not close to completion, accept, by the infrastructure federated learning orchestrator, the new party to join the federated learning;
spawn, by the infrastructure federated learning orchestrator, a container of the new party in an infrastructure of the infrastructure cluster; and
register, by the infrastructure federated learning orchestrator, a container process of the new party to the aggregator.

16. The computer system of claim 15, further comprising the program instructions executable to:
in response to determining one of: the bootstrapping is not feasible and the federated learning performed by the current parties is close to completion, deny, by the infrastructure federated learning orchestrator, the new party to join the federated learning.

17. The computer system of claim 11, further comprising the program instructions executable to:
monitor, by the infrastructure federated learning orchestrator, the aggregator for a no-party-response event;
in response to determining that the no-party-response event is detected, delete, by the infrastructure federated learning orchestrator, the containers of the parties;
create, by the infrastructure federated learning orchestrator, new containers of the parties;
restart, by the infrastructure federated learning orchestrator, processes of the parties;
restore, by the infrastructure federated learning orchestrator, local model states from persistent storage of the parties;
register, by the infrastructure federated learning orchestrator, new container processes of the parties to the aggregator; and
cause, by the infrastructure federated learning orchestrator, the parties to rejoin the federated learning.

18. The computer system of claim 11, further comprising the program instructions executable to:
collect, by the infrastructure federated learning orchestrator, performance metrics of the parties;
in response to determining that performance of a respective one of the parties is below a predetermined threshold, delete, by the infrastructure federated learning orchestrator, a container of the respective one of the parties;
create, by the infrastructure federated learning orchestrator, a new container of the respective one of the parties;
restart, by the infrastructure federated learning orchestrator, a process of the respective one of the parties, with better resources of the respective one of the parties;
restore, by the infrastructure federated learning orchestrator, a local model state from persistent storage of the respective one of the parties;
register, by the infrastructure federated learning orchestrator, a new container process to the aggregator; and
cause, by the infrastructure federated learning orchestrator, the respective one of the parties to rejoin the federated learning.

19. The computer system of claim 11, further comprising the program instructions executable to:
monitor, by the infrastructure federated learning orchestrator, the aggregator for an aggregator-fail event;
in response to determining that the aggregator-fail event is detected, delete, by the infrastructure federated learning orchestrator, the container of the aggregator;
create, by the infrastructure federated learning orchestrator, a new container of the aggregator;
restart, by the infrastructure federated learning orchestrator, the aggregator;
restore, by the infrastructure federated learning orchestrator, a global model state from persistent storage of the aggregator;
register, by the infrastructure federated learning orchestrator, container processes of the parties to the aggregator;
cause, by the infrastructure federated learning orchestrator, the parties to rejoin the federated learning; and
resume, by the infrastructure federated learning orchestrator, the aggregator and party processes of the federated learning.

20. The computer system of claim 11, further comprising program instructions executable to:
collect, by the infrastructure federated learning orchestrator, performance metrics of the aggregator;
in response to determining that performance of the aggregator is below a predetermined threshold, delete, by the infrastructure federated learning orchestrator, the container of the aggregator;
create, by the infrastructure federated learning orchestrator, a new container of the aggregator;
restart, by the infrastructure federated learning orchestrator, the aggregator on the new container with better resources;
restore, by the infrastructure federated learning orchestrator, a global model state from persistent storage of the aggregator;
restart, by the infrastructure federated learning orchestrator, the containers of the parties with local model states from persistent storage of the parties;
register, by the infrastructure federated learning orchestrator, container processes of the parties to the aggregator;
cause, by the infrastructure federated learning orchestrator, the parties to rejoin the federated learning; and
resume, by the infrastructure federated learning orchestrator, the aggregator and party processes of the federated learning.
